(19) United States
(12) Patent Application Publication
(10) Pub. No.: US 2004/0263356 A1
(43) Pub. Date: Dec. 30, 2004

(54) Automatic car toll paying method

(76) Inventors: Quen-Zong Wu, Taoyuan (TW); Ta-Wei Jain, Taoyuan (TW); Bor-Shenn Jeng, Taoyuan (TW)

Correspondence Address: RABIN & BERDO, P.C., Suite 500, 1101 14th Street, Washington, DC, 20005, US

(21) Appl. No.: 10/606,790

(22) Filed: Jun. 27, 2003

(51) Int. Cl. G08G 1/065

(52) U.S. Cl. 340/928; 705/13; 705/30

(57) ABSTRACT

An automatic car toll paying method is provided. Before a car enters a toll road or bridge, the user previously calls a specific number representing a log in of an automatic charging through a on-vehicle cellular communication equipment and then hangs up, and after leaving the toll road, the user calls a specific number representing a log out of the automatic charging. Continuously, wherein said on-vehicle cellular communication equipment has been logged in automatic charging when said car enters cell governing area of a communication coverage covering a toll station, the cellular base station will inform the billing center to automatically chargeback from an account connected to the on-vehicle cellular communication equipment or record the toll of the passing car. If the chargeback or the record is completed, the billing center will transmit a successful-payment message to the on-vehicle cellular communication equipment in the car through the cellular base station to be an electronic toll payment authorization.

### BACKGROUND OF THE INVENTION

1. Field of the Invention

The present invention relates to an automatic car toll paying method, and more particularly to an automatic car toll paying method which can be utilized in a car driving on the road or on the bridge.

2. Description of the Prior Art

The conventional automatic car toll paying method is disclosed by TW Patent Nos. 287264 (“Toll payment system”, reference 1) and 365671 (“Automatic car toll paying method”, reference 2). In reference 1, it includes an on-vehicle communication equipment, and an electronic account coupled to the communication equipment, wherein the electronic account is part of a cash system. And, the toll payment system includes a positioning communication equipment for positioning the communication equipment, and a distant communication equipment for communicating with the on-vehicle communication equipment and exchanging a valuable account transfer message through an assured encrypted figure to practice the toll payment.

Reference 2 disclosed an automatic toll paying method for a transportation tool driving on a highway or in an area, wherein each individual transportation tool sets a communication inputting device for communicating with a center unit and with a roadside unit in a substantial toll station and at least a virtual toll station which is geographically related to the substantial station previously decided. Moreover, the communication equipment of the transportation tool includes a receiver of a GNNS system which provides a signal and a first processor thereon to read a position of the transportation tool so as to compare with a position of the virtual toll station which is already stored in a memory for detecting a car which is entering the virtual toll station. Furthermore, the communication equipment of the transportation tool informs a transaction of the toll through a digital mobile transmission network of the center unit and then the center unit will process the toll transaction of the transportation tool and transmit a received note of the toll back to the transportation tool through the communication equipment. When arriving the substantial toll station, the communication equipment of the transportation tool will send the received note to the roadside unit through a communication therewith to be an evidence of the already paid toll.

References 1 & 2 described above both empoly a car positioning device for detecting and recognizing the car which arrives the toll station and then transmit a message about arrival of the car to the billing center through an on-vehicle communication equipment for charging the toll.

### SUMMARY OF THE INVENTION

An object of the present invention is to provide an automatic car toll paying method which employs a cellular phone with a on-vehicle cellular communication equipment to log in for paying the car toll when the car arrives the communication coverage covering the toll station and log out when leaving thereof.

For achieve the automatic car toll paying method described above, the main concept of the present invention is that each cellular base station has a limited communication coverage in the cellular phone system. And, because each cellular phone owns a cell ID, when an on-vehicle cellular communication equipment under using passes through one communication coverage and enters another communication coverage, the cell ID will be handed over to another cellular base station. Therefore, the toll of the car can be charged when the on-vehicle cellular communication equipment under using enters the communication coverage of the cellular base station which covers the toll station. However, for avoiding any cellular phone which is under using from being recognized to pay the toll, the user has to call a specific number representing a log in of an automatic payment through the on-vehicle cellular communication equipment previously. After the on-vehicle cellular communication equipment which has been logged in leaves the toll road, the user again has to call a specific number representing a log out of the automatic payment through the on-vehicle cellular communication equipment. When the on-vehicle cellular communication equipment therein which has been logged in for the automatic payment enters a communication coverage of a cellular base station covering the toll station, the cellular base station will inform the billing center to automatically chargeback from an account connected to the on-vehicle cellular communication equipment or record the toll of the passing car. If the chargeback or the record is completed, the billing center will transmit a successful-payment message to the on-vehicle cellular communication equipment through the cellular base station to be an electronic toll payment authorization. Moreover, the toll road or bridge further comprises an inspection location which sets one or more automatic photographing devices for recognizing a license plate, and when the car passes through the inspection location, the electronic toll payment authorization must be transmitted to a short wireless signal receiving device in the inspection location through an on-vehicle wireless DSRC (Dedicated Short Range Communication) transmitter. If the electronic toll payment authorization is not transmitted to the inspection location by the car, the license plate of the car will be recognized by the automatic photographing device and an image and a vehicle identification number of the car will be an evidence for processing a toll supplying.

### BRIEF DESCRIPTION OF THE DRAWINGS

The drawings disclose an illustrative embodiment of the present invention which serves to exemplify the various advantages and objects hereof, and are as follows:

FIG. 1 shows a state diagram of the automatic car toll paying method in a preferred embodiment according to the present invention; and

FIG. 2 shows a practicing schematic view of the automatic paying method for the car toll according to the present invention.

### DETAILED DESCRIPTION OF THE PREFERRED EMBODIMENT

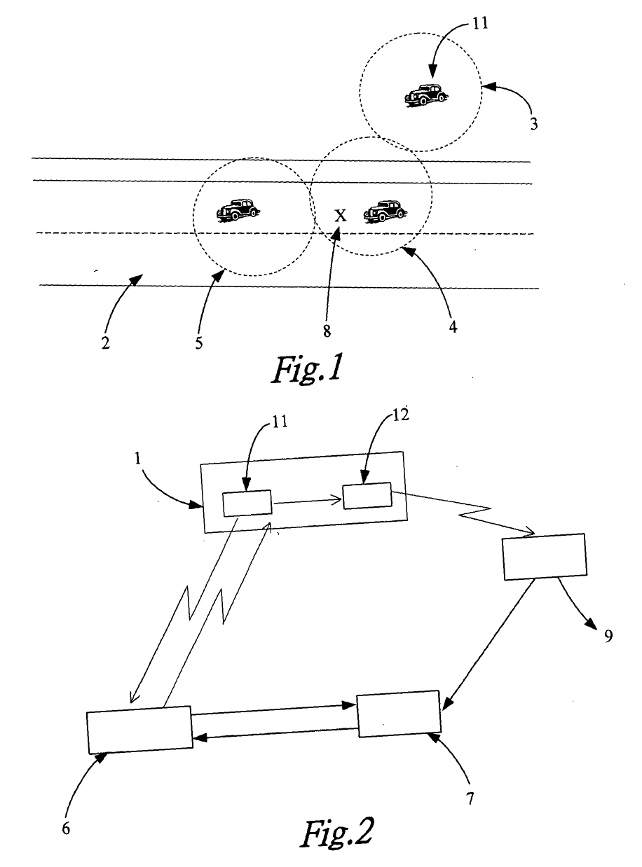

Please refer to FIG. 1 which illustrates a state diagram of an automatic car toll paying method according to the present invention. The main concept of the present invention is that each cellular base station has a limited communication coverage in the cellular phone system. And, because each cellular phone owns a cell ID, when an on-vehicle cellular communication equipment 11 under using passes through one communication coverage and enters another communication coverage, the cell ID will be handed over to another cellular base station. As show in FIG. 1, the car passes through the communication coverage 3 of cell A and enters the communication coverage 4 of cell B and the communication coverage 5 of cell C. In this condition, the car can be charged by the toll station 8 because the on-vehicle cellular communication equipment 11 under using enters the communication coverage 4 of cell B which covers the toll station 8.

FIG. 2 illustrates a practicing schematic view of an automatic car toll paying method in a preferred embodiment according to the present invention. FIG. 2 shows the interaction of an on-vehicle cellular communication equipment 11, an on-vehicle wireless DSRC (Dedicated Short Range Communication) transmitter 12, a cellular base station 6, a billing center 7, and a inspection location 9. Before the car enters a toll road 2 or bridge, the user previously empolys a hot key or the regular keyboard to call a specific number representing a log in of an automatic payment through the on-vehicle cellular communication equipment 11 and then hangs up. Continuously, when the car having the on-vehicle cellular communication equipment 11 therein which has been logged in enters a communication coverage of the cellular base station 6 covering the toll station 8, the cellular base station 6 will inform the billing center 7 to automatically chargeback from an account connected to the on-vehicle cellular communication equipment 11 or record the toll of the passing car. If the chargeback or the record is completed, the billing center 7 will transmit a successful-payment message to the on-vehicle cellular communication equipment 11 in the car through the cellular base station 6 to be an electronic toll payment authorization. Moreover, the toll road 2 or bridge further comprises the inspection location 9 which has one or more automatic photographing devices for recognizing a license plate, and when the car passes through the inspection location 9, the electronic toll payment authorization must be transmitted to a short wireless signal receiving device in the inspection location 9 through an on-vehicle wireless DSRC (Dedicated Short Range Communication) transmitter 12 in the car, wherein the wireless transmission can be a microware or an infrared transmission. If the electronic toll payment authorization is not transmitted to the inspection location 9 by the car, the license plate of the car will be recognized by the automatic photographing device and an image and a vehicle identification number of the car will be transmitted to the billing center 7 to be an evidence for processing a toll supplying.

Consequently, the automatic car toll paying method according to the present invention, when being compared with references 1 & 2 and the other prior arts, further includes the advantage as follows:

In the present invention, when being compared with references 1 & 2, it can detect and recognize the car which arrives the toll station without a car-positioning device equipped in the car, so that a lot of cost can be saved.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An automatic car toll paying method, comprising the steps of:
calling a specific number representing a log in of an automatic charging through an on-vehicle cellular communication equipment before a car enters a toll road or bridge and hanging up; and
calling a specific number representing a log out of said automatic charging through said cellular phone in said car after leaving said toll road or bridge,
wherein said on-vehicle cellular communication equipment has been logged in automatic charging when said car enters cell governing area of a communication coverage covering a toll station, a cellular base station will inform a billing center to automatically chargeback from an account connected to said on-vehicle cellular communication equipment or record said toll of said car.

2. The automatic car toll paying method according to claim 1, wherein said billing center will transmit a successful-payment message to said on-vehicle cellular communication equipment through said cellular base station to be an electronic toll payment authorization if said account or said record is completed.

3. The automatic car toll paying method according to claim 1, wherein said toll road or bridge further comprises an inspection location having one or more automatic photographing devices for recognizing a license plate, and when said car passes through said inspection location, said electronic toll payment authorization is transmitted to a short wireless signal receiving device in said inspection location through an on-vehicle wireless DSRC (Dedicated Short Range Communication) transmitter, and if said electronic toll payment authorization is not transmitted to said inspection location by said car, said license plate of said car will be recognized by said one or more automatic photographing devices and an image representing said car passing said inspection location and a vehicle identification number of said car will be an evidence for processing a toll supplying.

4. The automatic car toll paying method according to claim 3, wherein said on-vehicle wireless DSRC (Dedicated Short Range Communication) transmitter and said short wireless signal receiving device are microwave communication media.

5. The automatic car toll paying method according to claim 3, wherein said on-vehicle wireless DSRC (Dedicated Short Range Communication) transmitter and said short wireless signal receiving device are infrared communication media.

6. The automatic car toll paying method according to claim 1, wherein said on-vehicle cellular communication equipment employs a hot key conveniently to call said specific number representing said log in or said log out of said automatic payment.
